(19) United States
(12) Patent Application Publication
(10) Pub. No.: US 2012/0194853 A1
(43) Pub. Date: Aug. 2, 2012

(54) Page Validation Mechanism

(76) Inventors: Stephen G. Price, Longmont, CO (US); James T. Airola, Ward, CO (US); Samuel N. Hopper, Longmont, CO (US)

(21) Appl. No.: 13/018,620

(22) Filed: Feb. 1, 2011

(51) Int. Cl. G06F 3/12

(52) U.S. Cl. 358/1.15

(57) ABSTRACT

A method is disclosed. The method includes receiving print job data, rasterizing the print job data to produce rasterized bitmap data and validating the accuracy of the bitmap data during transmission of the rasterized bitmap data for printing.

### FIELD OF THE INVENTION

This invention relates generally to the field of printing systems. More particularly, the invention relates to image processing in printing systems.

### BACKGROUND

Printers are common peripheral devices attached to computers which allow a computer user to make a hard copy of documents that are created in a variety of applications and programs on a computer. To function properly, a channel of communication is established (e.g., via a network connection) between the printer and the computer to enable the printer to receive commands and information from the host computer. Once a connection is established between a workstation and the printer, printing software is typically implemented at a print server to manage a print job from job entry and management through the complete printing process.

In large, complex color printing systems, print data is transformed through multiple steps and transferred between multiple different computer systems data-processing cards. Such complex systems, which process sensitive business critical data, have the potential for hardware and software faults that may result in a system error or incorrect data being printed. Thus, various methods for verifying the printed data are often implemented.

One verification method is to use a camera or scanner to capture an image of actual printed output in order to perform a full or partial compare with bitmaps including the data that was expected to be printed. However, such systems are large, expensive, and difficult to integrate with the printing system. Moreover, simpler validation systems (e.g., side verify bar code or mark sensing system) used on printers provide only a cursory level of validation.

Accordingly, an efficient mechanism to validate print data is desired.

### SUMMARY

In one embodiment, a method is disclosed. The method includes receiving print job data, rasterizing the print job data to produce rasterized bitmap data and validating the accuracy of the bitmap data during transmission of the rasterized bitmap data for printing.

In another embodiment, a printer is disclosed. The printer includes a print server and a printer. The printer includes a control unit to receive print job data, rasterize the print job data to produce rasterized bitmap data and validate the accuracy of the bitmap data during transmission of the rasterized bitmap data for printing and one or more print engines to print the rasterized bitmap data.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a control unit; and

FIG. 3 illustrates one embodiment of a compute node;

FIG. 4 illustrates one embodiment of print engines; and

FIG. 5 is a flow diagram illustrating a process of verifying bitmap size.

### DETAILED DESCRIPTION

A mechanism to validate print data moving through a print system is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

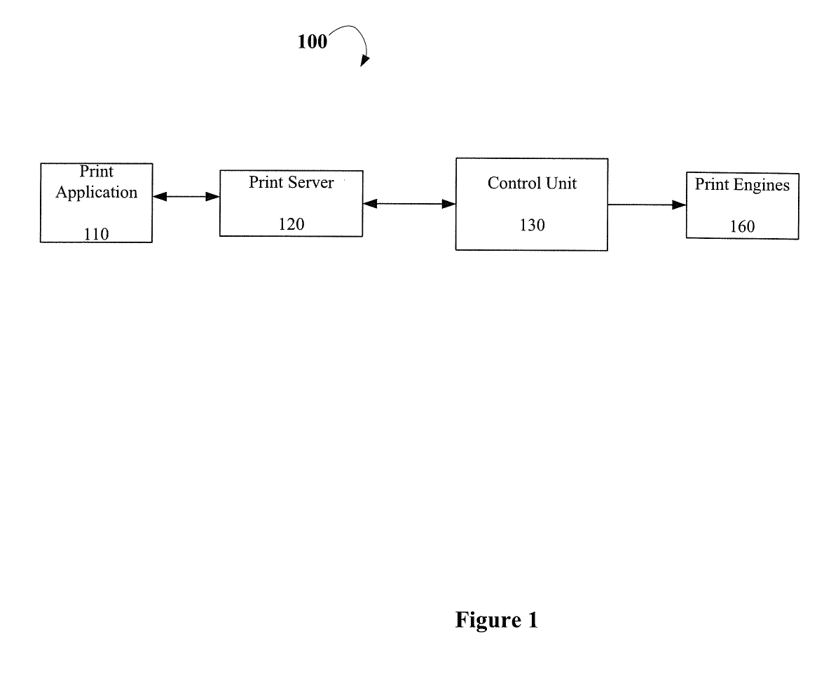

FIG. 1 illustrates one embodiment of a printing system 100. Printing system 100 includes a print application 110, a server 120, a control unit 130 and print engines 160. Print application 110 makes a request for the printing of a document. Print server 120 processes pages of output that mix all of the elements typically found in presentation documents, e.g., text in typographic fonts, electronic forms, graphics, image, lines, boxes, and bar codes.

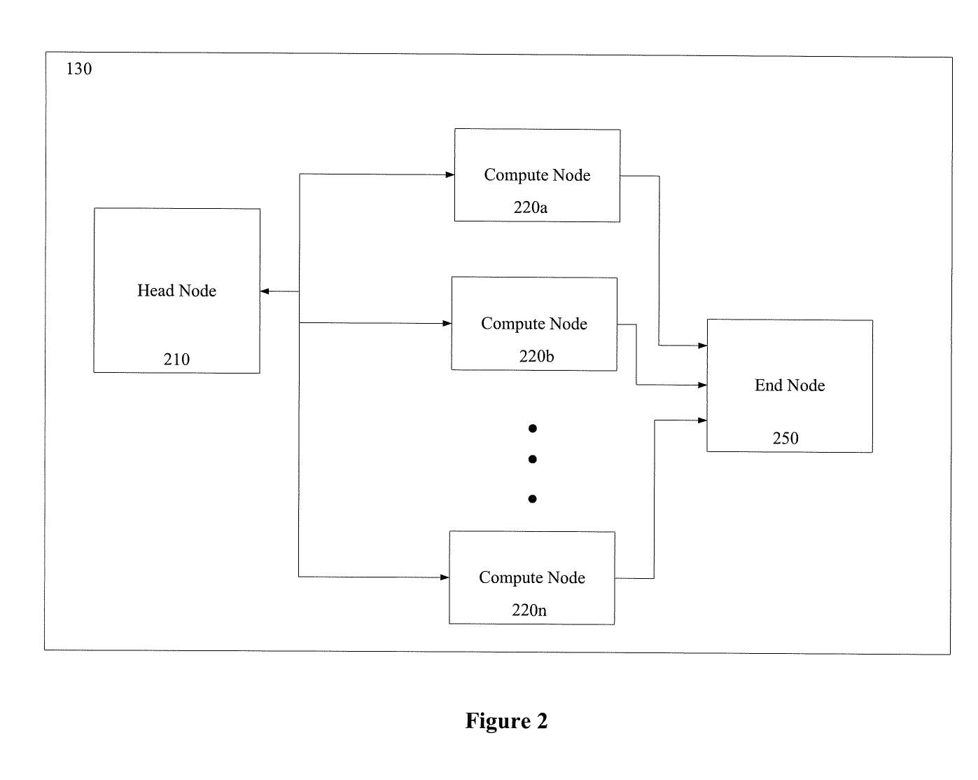

According to one embodiment, control unit 130 processes and renders objects received from print server 120 and provides sheet maps for printing to print engine 160. FIG. 2 illustrates one embodiment of a control unit 130. Control unit 130 includes a head node 210, multitude (e.g., ten) of compute node machines (compute nodes) 220a-220n and an end node.

Head node 210 receives print job data as data streams and partially processes a data stream by separating the data into sheet sides that are forwarded to compute nodes 220a-220n for processing. Compute nodes 220 rasterize the sheet sides received from head node 210. In one embodiment, each node 220 includes two or more parallel page output handlers (POH's). In a further embodiment, each POH includes a separate transform that processes received objects.

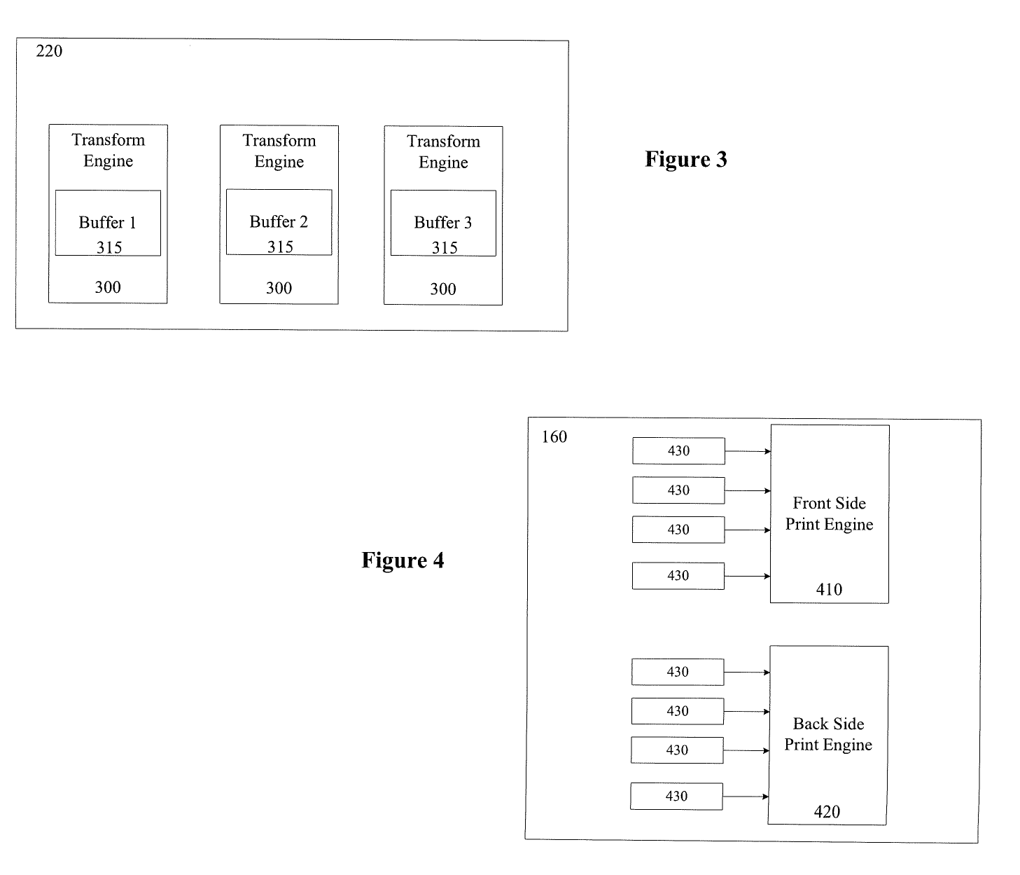

FIG. 3 illustrates one embodiment of a compute node 220. Compute node 220 includes transform engines (transforms) 310 implemented to process image objects by performing a raster image process (RIP) to produce a bitmap. In one embodiment, transforms 310 produce four-color bitmaps (e.g., cyan (C), magenta (M), yellow (Y) and black (K)) of each sheet side in continuous-tone format (e.g., 8 bits of data of each color for each spot in the bitmap). In a further embodiment, the RIP results in each page in a print job having the same dimensions, though parts of pages may be blank. Thus, the size of each page in terms of each bitmap's rectangular dimensions is independent of the data on the page.

In one embodiment, transforms 310 also compress each color plane of the bitmap in order to expedite transmission of the bitmap data to print engines 410. According to one embodiment, compute nodes 220 implement a lossless compression scheme (e.g., PackBits) for run-length encoding of the bitmap data. PackBits compresses raw data by looking for repeated strings having the same 8-bit value. A control byte is used to indicate repeat (negative values) or pass-thru (positive values) data. The absolute value of the control byte is the number of repeated or passed-thru values decremented by 1. For instance, values 0 thru 127 indicate that 1 thru 128 passed-thru values will follow the control byte, while values −1 thru −127 indicate that the following value is repeated for a total of 2 thru 128 times. The value −128 is not defined.

After compression, the compressed data for each color plane for an entire sheet side is partitioned into subcomponents that are stored in buffers 315 for separate transfer to end node 250 one at a time. When the end node signals that it is ready, the subcomponents are transmitted to end node 250. Subsequently, end node 250 transmits each subcomponent to print engines 160 via a cable connection.

According to one embodiment, end node 250 includes a dedicated data cable for each color plane for each engine. Thus, end node 250 transmits each compressed color plane over the dedicated connection for the respective color. Note that in other embodiments, end node 250 may include multiple cables for each color plane for engine, or may have fewer connections than colors and transmit multiple colors over each cable.

FIG. 4 illustrates one embodiment of print engines 160, which include a front side print engine 410 and back print engine 420. Print engines 160 also include bitmap interface cards 430 that receive the subcomponent data from end node 250 via the cables. The interface cards 430 store the data as full-page compressed bitmaps (e.g., still in 8-bit form) and later perform a halftone process on the data prior to transmitting the data for printing.

Because the data is transferred multiple times after being converted into bitmap form, there is an increased likelihood that important components of data may be lost or misplaced during the transfers; thus resulting in the erroneous printing of data. The erroneous printing of data could result in, for example, a customer billing statement including billing data from another customer.

According to one embodiment, control unit 130 includes a validation component that implements one or more validation mechanisms to verify the accuracy of bitmap data at various stages from transform to printing.

### Buffer Tracking

As discussed above, each subcomponent of a compressed bitmap is stored at a buffer 315 prior to being to end node 250 one at a time. According to one embodiment, each buffer 315 is provided an identification number. In such an embodiment, end node 250 verifies the buffer bitmap subcomponents number from which the subcomponent was received in order to confirm that the subcomponent was received in the proper sequence. For example, upon receiving a bitmap subcomponent from buffer 2, end node 250 checks the buffer bitmap subcomponents number to make sure that the subcomponent was received after a subcomponent from buffer 1 and before a subcomponent from buffer 3.

In a further embodiment, the interface cards 430 at print engine 160 also check the buffer number upon receiving a subcomponent. In still a further embodiment, control unit 130 provides an error indication upon a subcomponent being received out of order at either end node 250 or one of the interface cards 430. In response print system 100 may be shut down and an operator notified of the error.

### Bitmap Size Checking

Another mechanism to verify the accuracy of bitmap data is to frequently confirm that a bitmap matches its original size after each subcomponent is compressed and transmitted through to print engines 160. However since the bitmaps are compressed, the size of each page becomes variable. Therefore to perform the bitmap size checking, decompression and compression of the bitmaps would need to be performed each time a bitmap is checked, resulting in reduced system performance.

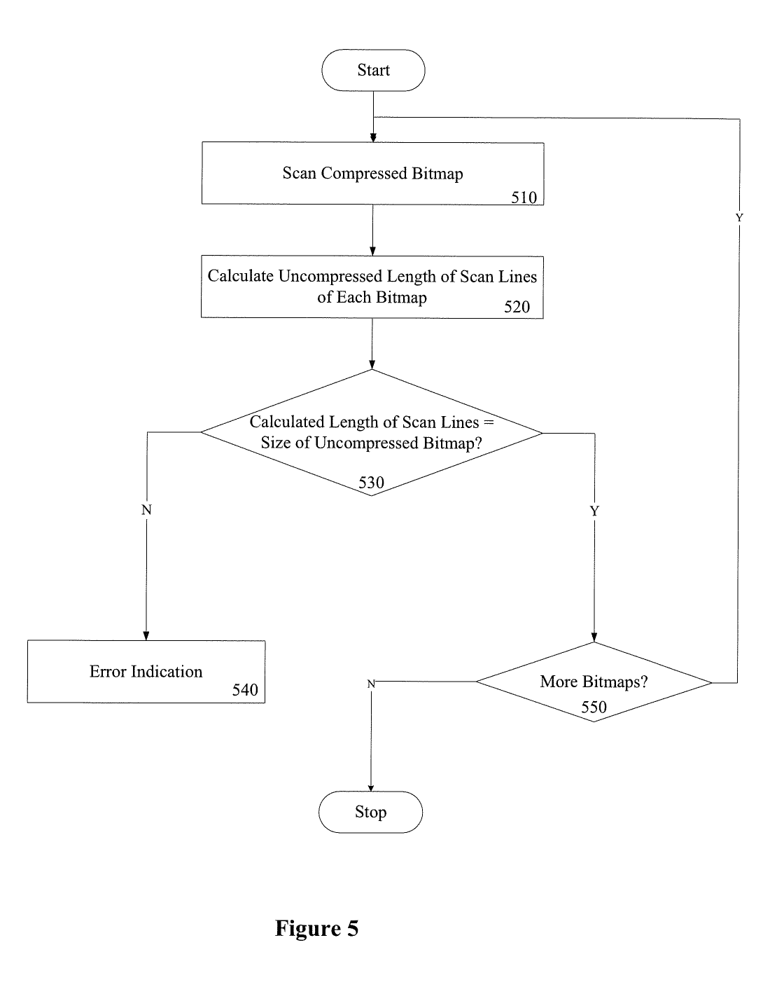

According to one embodiment, the compressed bitmaps are analyzed to verify bitmap size without decompressing the data. FIG. 5 is a flow diagram illustrating a process of verifying the size of a bitmap that is in a compressed format. At processing block 510, a compressed bitmap is scanned. At processing block 520, the uncompressed length of the scan lines in the bitmap is calculated. In one embodiment, this process is performed by calculating a sum length for each scan line and adding the resulting length to the previously calculated sums.

At processing block 530, it is determined whether the sum of the sizes represented by each of the compressed elements is equivalent to the actual size of the uncompressed bitmap. If not, an error indication is provided, processing block 550. In response print system 100 may be shut down and an operator notified of the error. If there is a size match, it is determined whether there are additional bitmaps to process, decision block 560. If there are additional bitmaps to process, control is returned to processing block 510 where the next compressed bitmap is scanned.

The above process may be performed at a compute node 220 after the data has been compressed, again before the data is transmitted to end node 250, as each subcomponent is transmitted to the end node 220. Moreover, the process may be performed at end node 220 as the data passes through. Further, the process may be performed in an interface card 430 as the data is received, while the data is stored there, and as the data is halftoned.

### Page Data Marking

According to one embodiment, additional data is included in the bitmap data to identify the start of each sheet side in a print job. In such an embodiment, the additional data is included by modifying the print data to place a special value into the bitmap at a predetermined location. In one embodiment, the special value is a fixed four-byte value placed at the beginning of the first scan line of each sheet side.

In a further embodiment, the chosen value is one that is unlikely to appear in normal print data, so as to avoid a false test result when the data is corrupted or shifted. In yet a further embodiment, the value is a small four byte value that is not visible to the naked eye. For example, the value should represent a very light color (e.g., 0x01020102, 0x01020304, or similar) on a blank page background implemented in many print jobs printed on production class printers.

According to one embodiment, the value is placed in the bitmap after the RIP process is performed by compute nodes 220 and before compression. However in other embodiments the value may be placed in the bitmap before the RIP process, so long as the RIP process protects the value from being overwritten. Once inserted in the bitmap, the predetermined location may be analyzed after each transfer (e.g., at end node 250 from compute node 220 and at interface card 430 card before halftoning sheet side) to verify that the special value is included. In one embodiment, the location is analyzed by to determine if the special value is present.

In other embodiments, multiple data values may be included to provide an approximate match for backgrounds that print at different densities. Therefore, the closest matching data marker value may be chosen based on the print that was intended to be printed at the specified location. For instance, two marker values may be chosen: one (e.g., 0x01020304) for light areas and one (e.g., 0xFEFDFCFB) for dark areas.

Subsequently, after the RIP process is performed on the page, the data in the marker location is compared to the plurality of marker values, with the closest matching marker value being chosen for insertion into the bitmap. When the verifications are later performed, another comparison is done to each of the possible marker values until a match is found.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A printer comprising:
a control unit to receive print job data, rasterize the print job data to produce rasterized bitmap data and validate the accuracy of the bitmap data during transmission of the rasterized bitmap data for printing; and
one or more print engines to print the rasterized bitmap data.

2. The printer of claim 1 wherein the control unit comprises:
a head node to receive the print job data;
a plurality of compute nodes to rasterize the data to produce the bitmap data, compress the bitmap data and partition the bitmap data into bitmap subcomponents; and
a plurality of buffers to temporarily store the bitmap subcomponents.

3. The printer of claim 2 wherein the control unit further comprises an end node to receive the bitmap subcomponents for transmission to the one or more print engines.

4. The printer of claim 2 wherein each buffer is assigned an identification number.

5. The printer of claim 4 wherein the accuracy of the bitmap data is validated at the end node by analyzing the buffer identification number associated with each bitmap subcomponent number to verify that each bitmap subcomponent was received from the compute nodes in a proper sequence.

6. The printer of claim 4 wherein the bitmap data is validated at the one or more print engines by analyzing the buffer identification number associated with each bitmap subcomponent number to verify that each bitmap subcomponent was received from the compute nodes in a proper sequence.

7. The printer of claim 2 wherein the bitmap data is validated by analyzing the compressed bitmaps to verify a size of each bitmap.

8. The printer of claim 7 wherein analyzing a compressed bitmap comprises scanning the compressed bitmap, calculating an uncompressed length of scan lines in the bitmap and determining if the uncompressed length of scan lines of the compressed bitmap is equivalent to the actual size of the bitmap.

9. The printer of claim 7 wherein the size of each bitmap is analyzed immediately after being compressed at the compute nodes.

10. The printer of claim 7 wherein the size of each bitmap is analyzed while stored in a buffer.

11. The printer of claim 7 wherein the size of each bitmap is analyzed at the end node.

12. The printer of claim 7 wherein the size of each bitmap is analyzed at a print engine.

13. The printer of claim 2 wherein the bitmap data is validated by placing additional data in the bitmap data to identify each sheet side in a print job.

14. The printer of claim 13 wherein the additional data is included by modifying the print job data to place a special value into the bitmap at a predetermined location.

15. The printer of claim 14 wherein the special value is analyzed after the compressed bitmap data has been received at the end node.

16. The printer of claim 14 wherein the special value is analyzed after the compressed bitmap data has been received at a print engine.

17. A method comprising:
receiving print job data;
rasterizing the print job data to produce rasterized bitmap data; and
validating the accuracy of the bitmap data during transmission of the rasterized bitmap data for printing.

18. The method of claim 17 further comprising:
compressing the bitmap data;
partitioning the bitmap data into bitmap subcomponents; and
storing each of the bitmap subcomponents in one of a plurality of buffers.

19. The method of claim 18 wherein each of the plurality of buffers buffer is assigned an identification number.

20. The method of claim 17 wherein validating the accuracy of the bitmap data comprises analyzing the buffer identification number associated with each bitmap subcomponent number to verify that each bitmap subcomponent was received from the compute nodes in a proper sequence.

21. The method of claim 18 wherein validating the accuracy of the bitmap data comprises analyzing the compressed bitmaps to verify a size of each bitmap.

22. The method of claim 21 wherein analyzing a compressed bitmap comprises:
scanning the compressed bitmap;
calculating the uncompressed length of scan lines in the bitmap;
and
determining if the uncompressed length of scan lines of the compressed bitmap is equivalent to the actual size of the bitmap.

23. The method of claim 18 wherein validating the accuracy of the bitmap data comprises placing additional data in the bitmap data to identify each sheet side in a print job.

24. The method of claim 23 wherein including the additional data comprises modifying the print job data to place a special value into the bitmap at a predetermined location.

25. The method of claim 23 further comprising analyzing the special value after the compressed bitmap data has been received at an end node.

26. The method of claim 23 further comprising analyzing the special value after the compressed bitmap data has been received at a print engine.

27. A printing system comprising:
a print server; and
a printer comprising:
a print engine; and
a control unit having:
a head node to receive the print job data;
a plurality of compute nodes to rasterize the data to produce the bitmap data, compress the bitmap data and partition the bitmap data into bitmap subcomponents;
a plurality of buffers to temporarily store the bitmap subcomponents;
an end node to receive the bitmap subcomponents for transmission to the one or more print engines; and
a validation unit to validate the accuracy of the bitmap data during transmission of the rasterized bitmap data to the print engine for printing.
